(19) United States
(12) Patent Application Publication
(10) Pub. No.: US 2008/0295336 A1
(43) Pub. Date: Dec. 4, 2008

(54) CUTTING TOOL HAVING THE FUNCTION OF A SHOVEL

(76) Inventor: Yao-Chung Huang, Fu Shing Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/755,493

(22) Filed: May 30, 2007

(51) Int. Cl. B25F 1/00

(52) U.S. Cl. 30/123

(57) ABSTRACT

A cutting tool includes two shanks pivotally connected with each other and each having a first end provided with an operation member which has a first side formed with a cutting blade and a second side formed with a shovel portion and a second end provided with a grip portion. Thus, the operation members of the shanks co-operate to provide a cutting or shearing function and to function as a shovel. In addition, the cutting tool can provide a cutting or shearing fiction and can function as a shovel so that a user can operate the cutting tool to perform two different works without having to replace a different tool, thereby facilitating the user operating the cutting tool.

### BACKGROUND OF THE INVENTION

1. Field of the Invention

The present invention relates to a cutting tool and, more particularly, to a pair of gardening shears.

2. Description of the Related Art

A conventional cutting tool, such as a pair of gardening shears, comprises two shanks pivotally connected with each other and each having a first end provided with a cutting blade and a second end provided with a grip portion. Thus, the cutting blades of the shanks are movable relative to each other to perform a cutting action. However, the conventional cutting tool only has a cutting or shearing function and cannot function as a shovel, so that a user has to replace the cutting tool by a shovel to perform the shoveling action, thereby causing inconvenience to the user.

### BRIEF SUMMARY OF THE INVENTION

In accordance with the present invention, there is provided a cutting tool, comprising two shanks pivotally connected with each other and each having a first end provided with an operation member which has a first side formed with a cutting blade and a second side formed with a shovel portion.

The primary objective of the present invention is to provide a cutting tool having the function of a shovel.

Another objective of the present invention is to provide a cutting tool, wherein the operation member of each of the shanks has a first side formed with a cutting blade and a second side formed with a shovel portion so that the operation members of the shanks co-operate to provide a cutting or shearing function and to function as a shovel.

A further objective of the present invention is to provide a cutting tool, wherein the cutting tool can provide a cutting or shearing function and can function as a shovel so that a user can operate the cutting tool to perform two different works without having to replace a different tool, thereby facilitating the user operating the cutting tool.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cutting tool in accordance with the preferred embodiment of the present invention.

FIG. 2 is an exploded perspective view of the cutting tool as shown in FIG. 1.

FIG. 3 is a schematic operational view of the cutting tool as shown in FIG. 1 in use.

FIG. 4 is a schematic operational view of the cutting tool as shown in FIG. 1 in use.

FIG. 5 is a partially front cross-sectional view of the cutting tool as shown in FIG. 4.

### DETAILED DESCRIPTION OF THE INVENTION

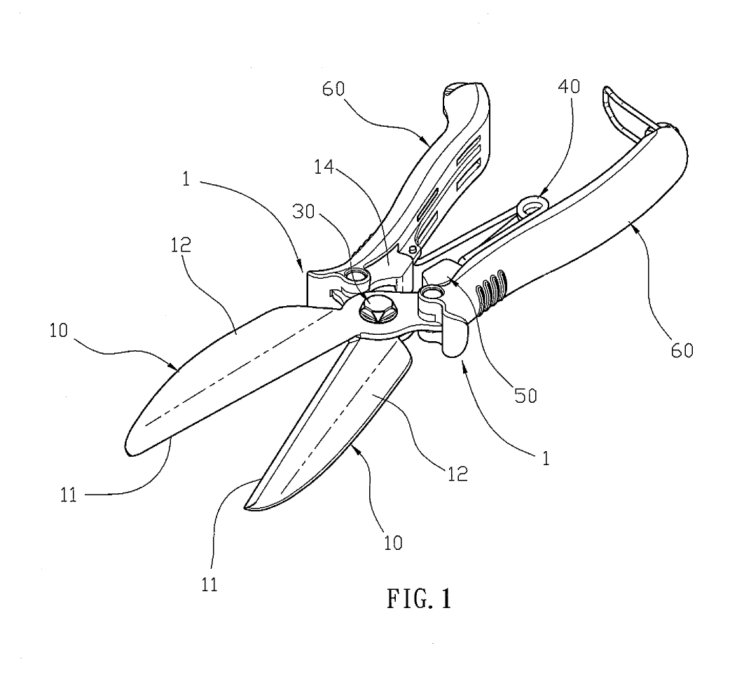

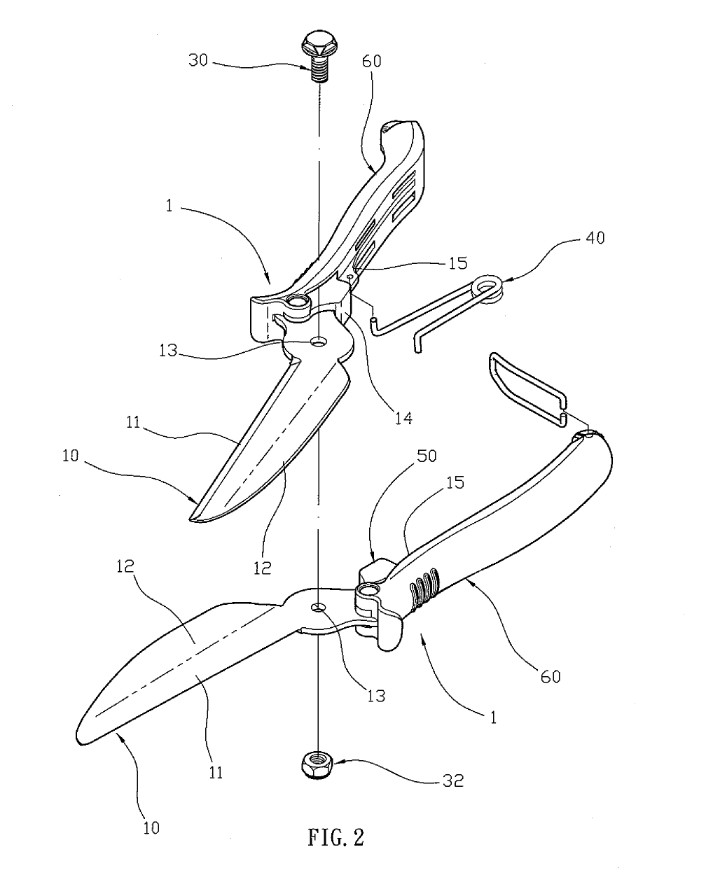

Referring to the drawings and initially to FIGS. 1 and 2, a cutting tool in accordance with the preferred embodiment of the present invention comprises two shanks 1 pivotally connected with each other and each having a first end provided with an operation member 10 which has a first side formed with a cutting blade 11 and a second side formed with a shovel portion 12.

Each of the shanks I has a second end provided with a grip portion 60. Each of the shanks 1 has a mediate portion located between the operation member 10 and the grip portion 60, and the mediate portions of the shanks 1 are pivotally connected by a pivot screw 30 and a fastening nut 32. The mediate portion of each of the shanks 1 is formed with a pivot hole 13 pivotally mounted on the pivot screw 30. The cutting blades 11 of the shanks 1 are directed toward each other, and the shovel portions 12 of the shanks 1 are directed outwardly relative to each other. The cutting blade 11 of each of the shanks 1 has a flat-shaped cross-sectional profile and is located at an inner side of the operation member 10 of each of the shanks 1, and the shovel portion 12 of each of the shanks 1 has an arc-shaped cross-sectional profile and is located at an outer side of the operation member 10 of each of the shanks 1. The shovel portion 12 of each of the shanks 1 extends outwardly and upwardly from the cutting blade 11 in a curved manner.

A torsion spring 40 is biased between the grip portions 60 of the shanks 1 to push the grip portions 60 of the shanks 1 outwardly relative to each other and to push the operation members 10 of the shanks 1 outwardly relative to each other. The grip portion 60 of each of the shanks 1 has an inner side provided with a fixing portion 15, and the torsion spring 40 has two distal ends each fixed on the fixing portion 15 of the respective shank 1.

One of the shanks 1 has an inner side formed with a snapping groove 14 located between the pivot hole 13 and the grip portion 60, and the other one of the shanks 1 has an inner side formed with a snapping member 50 that is located between the pivot hole 13 and the grip portion 60 and is snapped into the snapping groove 14 when the shanks 1 are movable toward each other.

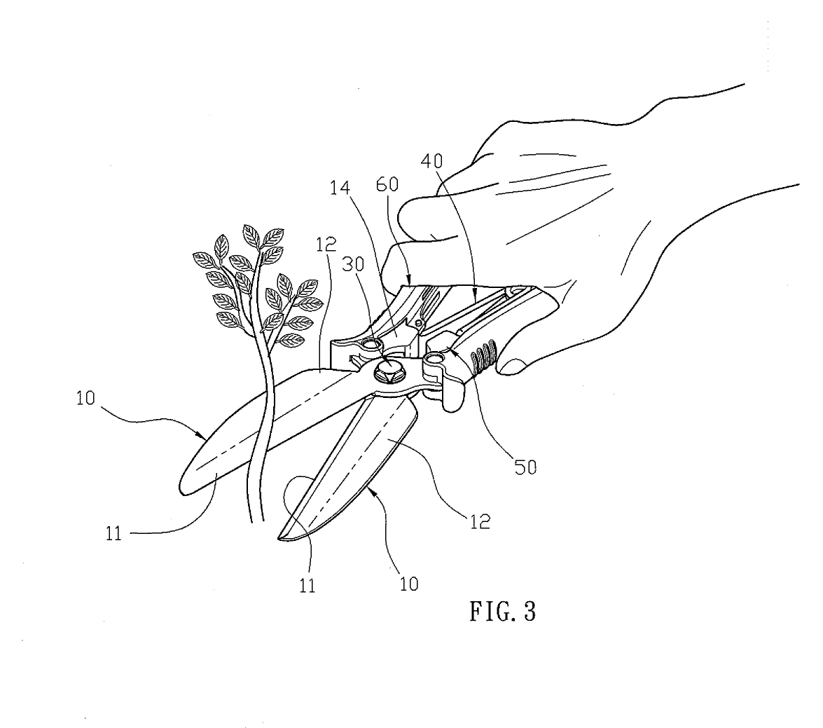

As shown in FIG. 3, the cutting blades 11 of the shanks 1 are movable relative to each other to perform a cutting action.

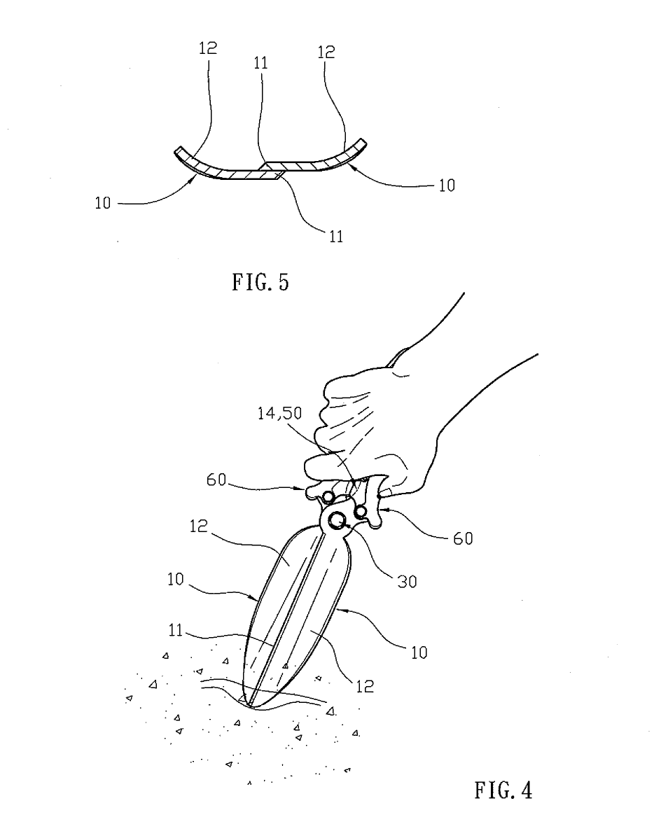

As shown in FIGS. 4 and 5, when the operation members 10 of the shanks 1 are juxtaposed to each other, the cutting blades 11 of the shanks 1 overlaps and intersect each other and are located between the shovel portions 12 of the shanks 1 so that the operation members 10 of the shanks 1 form a shovel so as to perform the function of a shovel.

Accordingly, the operation member 10 of each of the shanks 1 has a first side formed with a cutting blade 11 and a second side formed with a shovel portion 12 so that the operation members 10 of the shanks 1 co-operate to provide a cutting or shearing function and to function as a shovel. In addition, the cutting tool can provide a cutting or shearing function and can function as a shovel so that a user can operate the cutting tool to perform two different works without having to replace a different tool, thereby facilitating the user operating the cutting tool.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cutting tool, comprising:
two shanks pivotally connected with each other and each having a first end provided with an operation member which has a first side formed with a cutting blade and a second side formed with a shovel portion.

2. The cutting tool in accordance with claim 1, wherein each of the shanks has a second end provided with a grip portion.

3. The cutting tool in accordance with claim 2, wherein each of the shanks has a mediate portion located between the operation member and the grip portion.

4. The cutting tool in accordance with claim 3, wherein the mediate portions of the shanks are pivotally connected by a pivot screw and a fastening nut.

5. The cutting tool in accordance with claim 4, wherein the mediate portion of each of the shanks is formed with a pivot hole pivotally mounted on the pivot screw.

6. The cutting tool in accordance with claim 1, wherein the cutting blades of the shanks are directed toward each other, and the shovel portions of the shanks are directed outwardly relative to each other.

7. The cutting tool in accordance with claim 1, wherein the cutting blade of each of the shanks has a flat-shaped cross-sectional profile.

8. The cutting tool in accordance with claim 1, wherein the shovel portion of each of the shanks has an arc-shaped cross-sectional profile.

9. The cutting tool in accordance with claim 1, wherein the cutting blade of each of the shanks is located at an inner side of the operation member of each of the shanks, and the shovel portion of each of the shanks is located at an outer side of the operation member of each of the shanks.

10. The cutting tool in accordance with claim 1, wherein the shovel portion of each of the shanks extends outwardly and upwardly from the cutting blade in a curved manner.

11. The cutting tool in accordance with claim 2, further comprising a torsion spring biased between the grip portions of the shanks to push the grip portions of the shanks outwardly relative to each other and to push the operation members of the shanks outwardly relative to each other.

12. The cutting tool in accordance with claim 11, wherein the grip portions of each of the shanks has an inner side provided with a fixing portion, and the torsion spring has two distal ends each fixed on the fixing portion of the respective shank.

13. The cutting tool in accordance with claim 5, wherein one of the shanks has an inner side formed with a snapping groove, and the other one of the shanks has an inner side formed with a snapping member that is snapped into the snapping groove when the shanks are movable toward each other.

14. The cutting tool in accordance with claim 13, wherein the snapping groove is located between the pivot hole and the grip portion, and the snapping member is located between the pivot hole and the grip portion.

15. The cutting tool in accordance with claim 1, wherein when the operation members of the shanks are juxtaposed to each other, the cutting blades of the shanks overlaps and intersect each other and are located between the shovel portions of the shanks so that the operation members of the shanks form a shovel.
